(19) United States
(12) Patent Application Publication
(10) Pub. No.: US 2008/0317207 A1
(43) Pub. Date: Dec. 25, 2008

(54) Remote Communication Method and Device Unsing Nuclear Isomers

(76) Inventors: Robert Desbrandes, Givarlais (FR); Daniel Lee Van Gent, Baton Rouge, LA (US)

Correspondence Address: E-Quantic Communications SARL a capital variable, Allee des Cheriniers, Givarlais, F-03190, FR

(21) Appl. No.: 10/599,868

(22) PCT Filed: Mar. 28, 2005
(86) PCT No.: PCT/EP05/51405

§ 371 Date: Oct. 12, 2006

(30) Foreign Application Priority Data
Apr. 13, 2004 (FR) 0403904

(51) Int. Cl. G21G 4/00

(52) U.S. Cl. 378/120

(57) ABSTRACT

The invention relates to a method and device which are intended for remote control and communication using nuclear isomers. Several samples of nuclides that can have a metastable state are irradiated together and simultaneously with cascade gamma-rays emitted from a radioactive source or a particle accelerator. According to quantum mechanics, the gamma-rays produced are entangled, and said entanglement is transferred to the nuclear isomers. When the samples are separated and one of said samples, namely the master, is stimulated using a standard gamma- or X-ray irradiation method, the other samples, namely the slaves, are also deexcited. There is no known method for interference between the masters and slaves. Only the slave(s) can receive the signal instantly from the master through any medium and over any distance. The method and device are particularly suitable for communication and control applications.

### TECHNICAL FIELD

The present invention relates to a method and an apparatus to communicate remotely by using isomer nuclides.

Certain nuclides have a metastable state. These states are excited isomers, i.e. excited states of the atom nucleus. The isomers return to their ground state by isomeric transition while emitting a gamma radiation. The isomeric transition, like internal conversion, does not give place to a change of atomic number. In its normal state, an isomer returns to its ground state with an exponential law like the other radioactive elements. This exponential law is generally characterized by the half-life of the radioactive element. The half-life is connected to the probability of deexcitation by the formula:

P=LN(2)/λ
P, probability of disintegration per minute;
LN, natural logarithm;
λ, half-life in minutes.

For example, the half-life of normal Indium 115^{m} is 268 minutes. The probability of deexcitation of one nucleus per minute is 0.00258 that represents a chance on 387 per minute. By normal Indium 115^{m}, one indicates the classically excited isomer.

There are indeed several ways of exciting a nuclide likely to have a metastable state. It can be excited by neutron irradiation or simply come from the disintegration of an heavier nucleus. The excitation of the isomer nuclides can also take place by reverse isomeric transition due to an irradiation of gamma rays of sufficient energy.

It is known to the experts that the deexcitation of an isomer can be accelerated by X-ray or gamma irradiation. In this invention this property will be used.

The invention, whose implementation will be detailed below, exploits properties anticipated by Quantum Mechanics according to which two or several entangled particles preserve a quantum coupling when they are separated by any distance, quantum coupling which is instantaneous in the same referential.

Many articles and works exist on the subject of the entanglement. The main ones are listed hereafter:
[1.] Einstein A., Podolski B., Rosen N ., <<Can Quantum Mechanical Description of Physical Reality Be Considered Complete>>, Physical Review, 47, (1935), pp. 777-780.
[2.] Bell J. S., <<Speakable and Unspeakable in Quantum Mechanics>>, New York, Cambridge University Press, 1993.
[3.] Aspect A., <<Trois tests expérimentaux des inégalités de Bell par mesure de corrélation de polarisation de photons>>, Thèse de Doctorat d'Etat, Université de Paris Orsay, 1^{er} Février 1983.
[4.] Townsend P. D., Rarity J. G., Tapster P. R., <<Single-Photon Interference in 10 km Long Optical-Fiber>>, Electronics Letters, V; 29, p. 634, 1993.
[5.] Le Bellac M., <<Physique Quantique>>, EDP/Sciences/CNRS, 2003, voir <<Etats Intriqués>>, p. 165-201.
[6.] Aczel A. D., <<ENTANGLEMENT: The Greatest Mystery in Physics>>, John Wiley & Sons, LTD, Chichester, W. Sussex, England, 2003.
[7.] Aczel A. D., <<ENTANGLEMENT: The Unlikely Story of How Scientists, Mathematicians, and Philosophers Proved Einstein's Spookiest Theory>>, A Plume Book, September 2003.
[8.] Shimony A., <<The Reality of the Quantum World”, Scientific American, p. 46, January 1998.
[9.] Greestein G., Zajonc A. G., <<The Quantum Challenge: Modern Research on the Foundations of Quantum Mechanics>>, Jones and Barlett, Sudbury, Mass., USA, 1997.
[10.] Herbert Nick, “Quantum Reality”, Anchor Book, NY, 1985.
[11.] Carroll M. J., Bird, D. G., et al., <<Photoexcitation of nuclear Isomers by (γ,γ′) reactions>>, Physical Review C, 43, 3, p. 1238-1245.
[12.] Magniez F. <<Cryptographie Quantique>>, Mémoire magistère, ENS-Cachan, mai 1993.
[13.] Muller, A., Breguet J., Gisin N., “Experimental Demonstration of Quantum Cryptography using Polarized Photons in Optical-Fiber over more than 1 KM”, Europhysics Letters, V. 23, p. 383, 1993.
[14.] Sudbury Tony, <<Instant Teleportation>>, Nature, V. 362, pp. 586-587, 1993.
[15.] Nairz O., Arndt M., Zeilinger A., <<Experimental Nonlocality Proof of Quantum Teleportation and Entanglement Swapping>>, Physical Review Letters, V. 88, p; 017903, 2002.
[16.] Julsgaard B., Kozhekin A., and Polzik E; S., <<Experimental long-lived entanglement of two macroscopic objects>>, Nature, 413, 400-403, (2001).
[17.] Olariu S. et Olariu A., <<Induced emission of γ radiation from isomeric nuclei>>, Physical Review C, 58, 1, (July 1998).

### BACKGROUND OF THE INVENTION

The technique of entanglement of photons is used in cryptography. This makes it possible to transmit messages between two corresponding persons. The detection of the messages by a third person is immediately known to the corresponding persons, a conventional connection remains however necessary to decode the messages. The technique of entanglement of the nuclides contained in the macroscopic objects which is used in this invention for the remote communication is not known to the expert.

### BRIEF SUMMARY OF THE INVENTION

The present invention consists in irradiating simultaneously, by the method described below, two or several samples of the same element that are susceptible to have a metastable state. When this irradiation is caused by gamma rays emitted by the same nucleus and in a cascade, the half-life varies with time instead of being constant. A similar phenomenon but even more important is obtained with gamma obtained by Bremsstrahlung in a particle accelerators. This phenomenon is due to the entanglement of the irradiated nuclei of the metastable isotope. One will consider initially two samples: After irradiation; the two samples are then separated in space. One of the samples, which we will call the “master”, is stimulated using x-rays or gamma whereas the other, the “slave”, is placed on a detector of gamma rays. The stimulation of the “master” causes the deexcitation of the “slave” who is measured by the detector of gamma rays.

This invention is generalized with a plurality of samples irradiated together, each sample, can then be “master” and/or “slave”, in successive implementations of the invention. The stimulation of at least one “master” sample causes the deexcitations of one or more “slaves” samples, such deexcitations are measured by detectors of gamma rays. Given the quantum nature of the transmission, there is no known method of interference between the “master” samples and the “slave” samples. The samples irradiated together are the only ones being able to receive instantaneously the signals of the “master” samples whatever the distances separating the samples.

Implementations of the invention were made with a source of Cobalt 60 of which each nucleus has the characteristic of emitting in a cascade two gamma rays with sufficient energy to excite Indium 115. Other implementations of the invention were made by exciting Indium 115 with gamma rays coming from a compact linear accelerator. The gamma spectrum extends from 0 to 6 MeV, but is centered on 1.5 MeV, i.e. that, in majority, two, three or four gamma rays are emitted in a cascade by the same electron, when the accelerator uses electrons. At the time of the cascades some of the emitted gamma rays, X-rays or optic rays are entangled. The present invention makes use of entangled gamma rays to excite the isomer nuclei. These gamma rays come, as indicated previously, of nuclear reactions such as the disintegration of Cobalt 60 or the phenomenon of Bremsstrahlung in the particle accelerators.

One measures the gamma activity in particular for the energy of the isomeric transition on the slave sample. A diagram of this implementation is illustrated in FIG. 1. A chamber (1) with a wall of 3 mm of copper, 15 cm of lead and 12 mm of steel contains the gamma counter (10) and the slave sample (8) which emits gamma (9) naturally. At a distance of 12 m (7), the master sample (4) is stimulated by the source of Iron 55 (2) which emits gamma rays and x-rays (3). The stimulation, well-known of the experts, is brought forth and additional gamma rays (5) are emitted by master sample (4). At the same time, the stimulation of master sample causes an additional emission from the slave sample (8) although it is inside its thick shielding and 12 m away from the master sample.

FIG. 2 is an example of measurements made on indium sheets with 99.999% of purity, beforehand and simultaneously irradiated during 20 minutes with a compact linear accelerator. The source of x-ray and gamma, of Iron 55 type, was placed during 5 minutes on the master sample, noted “YES”, then withdrawn during 5 minutes, noted “NO” and so on. Measurements of FIG. 2 represent the total counting during the 5 minutes of irradiation of the master, the 5 minutes without irradiation and so on. An important signal on the slave is obtained for the periods of irradiation of the master, except the last period for which no signal was obtained. The same experiments made with the source of Cobalt 60 give identical results but almost not higher than the noise.

### BRIEF DESCRIPTION OF THE DRAWINGS AND TABLES

FIG. 1 schematically represents the principle of the method used in the invention to remotely communicate.

FIG. 2 represents an example of experimental result obtained with two Indium samples 115 irradiated with the gamma rays of a compact linear accelerator. In this test, the samples are separated from 12 m.

FIG. 3 illustrates a mode of implementation of the invention with a radioactive source and a plurality of couples of samples.

FIG. 4 illustrates a mode of implementation of the invention with a particle accelerator and a plurality of couples of samples placed on a single disk.

FIG. 5 illustrates a mode of implementation of the invention with a particle accelerator and a plurality of couples of samples placed on two superimposed disks.

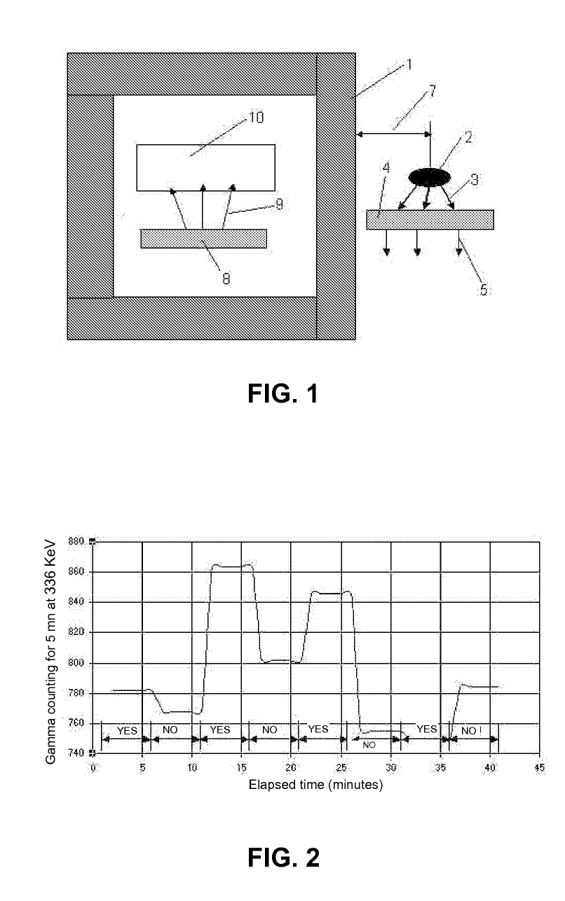

Table 1 enumerates a list of the main nuclei having a metastable state with their symbol, abundance, half-life and gamma ray emission.

### MODES FOR CARRYING OUT THE INVENTION

Manners of implementing the invention are described below. However it is specified that the present invention can be implemented in various ways. Thus, the specific details mentioned below should not be understood as limiting the implementation, but rather as a descriptive base to support the claims and to teach the specialist of the profession the use of the present invention, in practically all systems, structures or modes.

The present invention can be implemented with nuclides of various half-lives. Indeed, the half-lives of the metastable nuclides usable for this invention extend from one microsecond to 50 years. Table 1 gives a list of the main nuclides which have a metastable state. Their symbol, abundance, half-life in ordinary excitation and their isomeric energy of transition are mentioned. The excited samples can be moved onto large distances and wait for long periods, if their half-life allows it, while being always likely to be deexcited.

The implementations of the invention, which are described, concern a master and a slave, but a master can deexcite a plurality of slaves if a plurality of samples were excited together. In the same way, a slave can receive a signal of any master. The action takes place whatever the distance or the materials which separates master and slave.

The method according to the invention consists in irradiating with gamma rays two or several samples of an element having a metastable state with a half-life duration extending from less than one second to several years. The gamma rays used for the excitation of the samples must come either from a disintegration in a cascade in the case of a radioactive isotope, or of the Bremsstrahlung effect in which the same particle emits several gamma.

For example, an emission in a cascade is provided by Cobalt 60. The emitted gamma rays must have a sufficient energy to carry out an reverse isomeric transition, i.e. to make the nucleus go from its ground state to a metastable state. In the case of Indium 115, for example, the energy necessary for the threshold of excitation is of 1,080 keV, condition which is met by the two gamma rays of Cobalt 60. One of the gamma has an energy of 1,173 keV with 99.90% chance to occur, and the other 1,332 keV with 99.98% chance to occur. We definitely have a cascade because the two gamma are emitted a 0.713 picosecond (10⁻¹² s) interval on average.

In the case of an irradiation by Bremsstrahlung gamma rays from a linear accelerator of particles, for example of electrons, the energy of the gamma must again be higher than the threshold of excitation of the selected element.

For example, a compact linear accelerator can emit a gamma radiation very focused with a spectrum of energy gamma from 0 to 6 MeV. If the energy of all the electrons before meeting the Tungsten target is 6 MeV, each electron emits on average four gamma of 1.5 MeV (1,500 keV) in a very fast succession comparable with a cascade. The gamma cascade of the accelerator is, as the experiment shows, more efficient to carry out the work described in this invention.

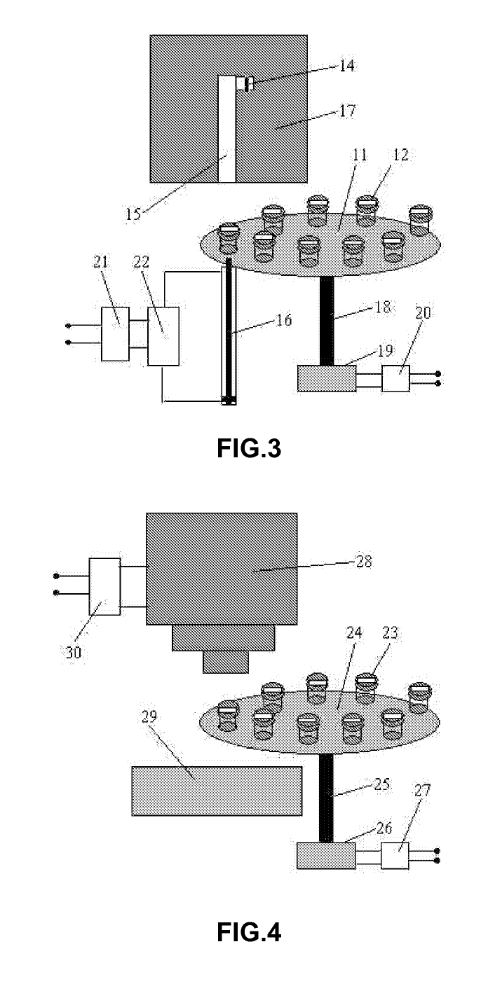

According to a particular mode of the invention represented on FIG. 3, which relates to an irradiation with radioactive source emitting gamma in a cascade, the samples to be irradiated are placed by couple or more on a tray (11), which presents the groups of samples (12) in succession in front of a piston (16), which introduces them opposite a radioactive source (14) by the opening (15) using the piston. The source is placed in a thick steel and lead shielding (17). An axis (18) connects the tray to a stepper motor (19) controlled by a timer (20). The time of irradiation is adjusted for each group of samples using a timer (21), which actuates a pneumatic valve (22), to obtain the optimal response of activation. In the case of Indium 115, with a source of 111,000 GBq (3,000 Ci), several hours of excitation are necessary.

According to another mode of implementation of the invention, schematized on FIG. 4, the groups of samples (23) are placed on a rotating tray (24). This tray is supported by an axis (25) and is connected to one stepper motor (26), itself controlled by a timer (27). The groups of samples are presented, for example, one after the other in front of the beam of x-rays of a compact linear accelerator (28). A “phantom” (29) filled with water stops the gamma rays not absorbed. In general the accelerators cannot function permanently. A certain number of units of time of irradiation, for example 5 minutes, will be applied to each sample to obtain the optimal excitation using a timer (30). In the case of Indium 115, a 20 minutes excitation with a compact linear accelerator is enough to have a satisfactory signal to noise ratio.

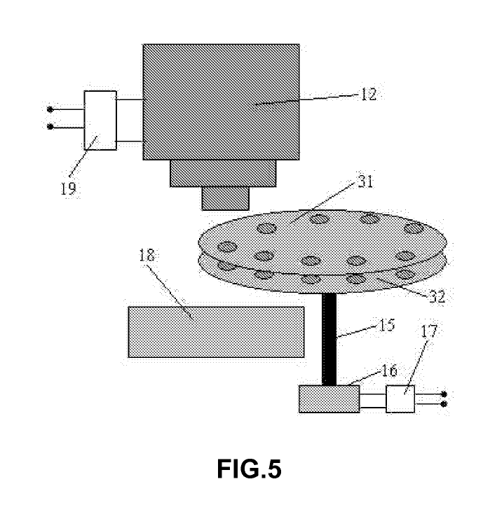

An ordered ensemble of independent couples of samples can also be irradiated, as shown in the FIG. 5. On this figure, the couples of samples are laid out on two disks, the master disk (31) and the slave disk (32), during the irradiations. The other elements of FIG. 5 are identical to those of FIG. 4. These disks can then be removed to any distance and exploited by modulated stimulation of deexcitation of each ordered sample in the master disk. The reception of this modulation by the corresponding sample of the slave disk, thus allows the transmission of a complex message. If several samples, placed on several disks, are excited together instead of on a couple of disks, the message can be transmitted simultaneously to several slave disks. Other supports than disks can be used. For example, platelets can be presented in translation in front of the generator of gamma emitted in a cascade.

The apparatuses described previously are examples of implementation. Other means to present the samples to the irradiation can be employed without leaving the framework of the invention.

The master-slave groups of samples to be irradiated are solids in sheet or powder, fluids or gases (case of Xenon for example), which contain, for example, a proportion of one or several isotopes mentioned on Table 1. The samples can also be alloys, mixtures or chemical compounds incorporating a proportion of one or several isotopes of Table 1. The samples of the same group can be of different nature, for example, one in a powder form and the other in the form of a sheet. One or more of the samples of the same group can also be transformed physically or chemically after irradiation, slave sample in the form of powder or of a gas can be, for example, incorporated in an injectable carrying molecule. The isomer, a salt or a molecule containing the isomer, can also be put in solution in the sample. Several isomers can be employed in this solution.

Measurements of gamma due to the isomeric transition in the slave during the stimulation of the master can be taken with the conventional instruments of the experts. A common instrument is the detector functioning with a germanium crystal at low temperature. In order to minimize the effects of the cosmic rays, radon and the ambient interferences, slave sample can be placed in an enclosure with walls of copper, lead and steel, located at a long distance from master sample (12 m in the implementation mentioned previously). A multiple-channel analyzer must be able to be tuned on the characteristic radiation of the selected isomer. For example, in the case of Indium 115^{m}, the gamma in the 336.2 keV line are counted. It is also possible that progress of the technique makes it possible to measure the radiation of 336.2 keV without having a special enclosure.

A time modulation of the stimulations of deexcitation, as in the example of FIG. 2 shows it, can be used to send a message made up of “yes” and of “no”, that is to say, of 1 and 0 in binary language, on one or several samples. Implementations of the invention with more complex modulations such as a frequency or amplitude modulation of deexcitation stimulations can also be used.

According to the known techniques' of stimulation of isomers, one can choose the optimal radiation to stimulate a particular isomer. Consequently, the master sample containing a mixture of isomers can be selectively excited. Each isomer thus represents in this case a particular “channel” of transmission.

When the isomer emits, naturally or during remote stimulation, some gamma of several energies, the measurements made for each energy make it possible to improve the signal to noise ratio.

### INDUSTRIAL APPLICABILITY

This invention thus solves a technical problem of transmission of information, very crude for the moment, but nevertheless of great novelty.

Various industrial applications are immediately possible, emergency signals, remote controls, data acquisition, in mines, on sea-beds (robots and submarines), in drillings, in space, in particular at very long distances, etc

Medical applications are also possible by remotely stimulating the product according to the invention, of which one slave sample can be placed close or in the organ to be treated.

TABLE 1

| | | | Half- | | |
|---|---|---|---|---|---|
| Nuclide | Symbol | Abundance % | life | | Gamma keV |
| Niobium | 93Nb41 | 100 | 16.3 | y | 31.8 |
| Cadmium | 111Cd48 | 12.8 | 48.54 | m | 396.2 |
| Cadmium | 113Cd48 | 12.2 | 14.1 | y | 263.5 |
| Cesium | 135Ce | — | 53 | m | 846/786 |
| Indium | 115In49 | 95.7 | 4.48 | h | 336.2 |
| Tin | 117Sn50 | 7.7 | 13.6 | y | 314.6 |
| Tin | 119Sn50 | 8.6 | 293 | d | 60.5 |
| Tellurium | 125Te52 | 7.1 | 57.4 | d | 144.8 |
| Xenon | 129Xe54 | 26.5 | 8.8 | d | 238.1 |
| Xenon | 131Xe54 | 21.2 | 11.8 | d | 163.9 |
| Hafnium | 178Hf72 | 27.3 | 31 | y | 574/ . . . /93 |
| Hafnium | 179Hf72 | 13.6 | 25 | d | 453/ . . . /122 |
| Iridium | 193Ir77 | 62.7 | 10.5 | d | 80.2 |
| Platinum | 195Pt78 | 33.8 | 4 | d | 259.3 |

m: minutes,
h: hours,
d: days,
y: years.

1) Simple product consisting in two or more samples containing at least one kind of excited isomer nuclides in which at least one said excited isomer nuclide has at least one metastable state that deexcites by emitting gamma rays, called hereafter deexcitation gamma rays, characterized in that groups of two or several excited nuclei of the aforesaid excited isomer nuclides of the aforesaid samples, are entangled together and are distributed in whole or in part of the aforesaid samples, called thereafter by convention “entangled” samples, the aforementioned “entangled” samples being able to be separated in space and presenting quantum couplings between some of the excited nuclei of the aforesaid excited isomer nuclides contained in these separate samples.

2) Simple product according to claim 1 characterized in that said “entangled” samples comprises said excited nuclei of at least one kind of said excited isomer nuclides having at least one said metastable state with a duration of its half-life from one microsecond to 50 years, for example Niobium (93Nb41 m), Cadmium (111Cd48m), Cadmium (113Cd48m), Cesium (135Ce55m), Indium (115In49m), Tin (117Sn50m), Tin (119Sn50m), Tellurium (125Te52m), Xenon (129Xe54m), Xenon (131Xe54m), Hafnium (178Hf72m), Hafnium (179Hf72m), Iridium (193Ir77m), or Platinum (195Pt78m), the aforementioned “entangled” samples being able to be moved over large distances and to wait long periods, if their half-life allows it, while being always likely to be deexcited.

3) Simple product according to claim 1 characterized in that said “entangled” samples are in any physical form or chemical form, for example the form of solids in sheet or powder, or the form of fluids or gases (for example case of Xenon), which contain a proportion of at least one or several aforesaid isomer nuclides, for example Niobium (93Nb41m), Cadmium (111Cd48m), Cadmium (113Cd48m), Cesium (135Ce55m), Indium (115In49m), Tin (117Sn50m), Tin (119Sn50m), Tellurium (125Te52m), Xenon (129Xe54m), Xenon (131Xe54m), Hafnium (178Hf72m), Hafnium (179Hf72m), Iridium (193Ir77m), Platinum (195Pt78m), or in the form of alloys, mixtures, or in the form of chemical compounds incorporating a proportion of one or several of the aforesaid excited isomer nuclides.

4) Simple product according to claim 1 characterized in that it includes said “entangled” samples, of which one at least is in a physical form and/or a chemical form different from the form of one or several other said “entangled” samples, for example one in the form of powder and the other in the form of a sheet, or one in the form of a solid, or in the form of powder or gas and the other incorporated in injectable carrying molecules for example, in salts or molecules put in solution.

5) Manufacturing process of the simple product according to the claim 1 in which one uses amongst other things:
(a) at least a kind of isomer nuclides,
(b) irradiation by gamma rays,
characterized in that the following steps are carried out:
(a) one prepares together samples containing nuclei of at least one kind of isomer nuclides having at least one metastable state,
(b) one proceeds to the irradiation by means of gamma rays, at least partly entangled, of a sufficient energy to excite certain of the aforesaid nuclei of the aforesaid isomer nuclide to at least one metastable state, the said entangled gamma rays forming groups which are generated, for example, either by a source of gamma rays emitted in a cascade, or by a generator of gamma rays coming from the Bremsstrahlung of accelerated particles, the groups of said gamma rays, when they are entangled, exciting the corresponding said nuclei of the said isomer nuclides distributed in the said samples irradiated together and forming the “entangled” samples of the aforesaid simple product.

6) Method according to claim 5 characterized in that one uses aforementioned “entangled” samples of which one at least has undergone a physical and/or a chemical transformation after the aforementioned irradiation.

7) Use of the simple product defined according to claim 1 in which one uses amongst other things:
(a) at least one kind of isomer nuclides,
(b) the stimulation of the deexcitation by X-ray or gamma irradiation of at least one kind of isomer nuclides,
(c) either the detection of gamma radiation measuring at least one line characteristic of one kind of isomer nuclides, or the gamma radiation as such, or a combination of these exploitations,
characterized in that the following steps are carried out in order to control a remote deexcitation by employing aforementioned “entangled” samples:
(a) one separates in space whole or part of the said “entangled” samples of the aforesaid simple product containing aforementioned excited nuclei of the aforesaid excited isomer nuclide presenting some quantum couplings, certain of the aforesaid excited nuclei of the aforesaid excited isomer nuclide being distributed on some of these said “entangled” samples,
(b) one exploits said quantum couplings between said excited nuclei of certain of the said “entangled” samples of the aforesaid simple product, independently of the distances, mediums separating them and independently from the mediums in which these said “entangled” samples are placed:
(i) by causing at least a modulated stimulation of the deexcitation by X-ray or gamma irradiation, for example obtained by means of a source of Iron 55, within at least one of the aforesaid “entangled” samples, qualified as “entangled” “master” sample, the said modulated stimulation inducing, by means of the aforesaid quantum couplings, a remote deexcitation of one or more of the other aforesaid “entangled” samples, qualified as “entangled” “slaves” samples; the aforesaid modulated stimulation applied to the said “master” sample characterizing at least one information or at least one control to be transmitted,
(ii) and, either by determining, either at least one detection of information, or at least one detection of remote control, by means of at least one measurement made with a detector of gamma radiation, of at least an additional modulated deexcitation on at least one line characteristic of at least one aforesaid isomer nuclide contained in at least one of the other aforesaid “entangled” “slave” samples, or by using the gamma radiation resulting from the additional modulated deexcitation from at least one aforesaid isomer nuclide contained in at least one of the other aforesaid “entangled” “slave” samples, as a local control, or by using at least one of the other aforesaid “entangled” “slave” samples, as a product of which the irradiation is operated by remote control from the aforesaid “entangled” “master” sample to irradiate the environment of the said “entangled” “slave” sample, or a combination of these exploitations.

8) Use according to claim 7 characterized in that one employs aforementioned “entangled” samples containing aforementioned excited nuclei of at least two aforementioned isomer nuclides, whose gamma response of at least one said “entangled” “slave” sample either is measured, or is used to irradiate its environment.

9) Use according to claim 7 characterized in that one employs aforementioned “entangled” samples containing aforementioned excited nuclei of at least one aforementioned isomer nuclide, of which the gamma response is made up of a plurality of lines from which at least two lines are measured simultaneously, for example to improve the signal to noise ratio during the measurement carried on the aforementioned “entangled” “slave” sample or on the aforementioned “entangled” “slave” samples.

10) Use according to claim 7 characterized in that the aforementioned modulated stimulation is specified in amplitude on at least one aforementioned “entangled” “master” sample.

11) Use according to claim 7 characterized in that the aforementioned modulated stimulation is specified in time on at least one aforementioned “entangled” “master” sample.

12) Complex product comprising a plurality of simple products according to claim 1 of simple product characterized in that a plurality of sets of aforementioned “entangled” samples, each set of said “entangled” samples constituting a product according to claim 1, are laid out in relation to each other on at least two supports, for example disks, called thereafter by convention “entangled” supports, for example by positioning an “entangled” sample of each set of “entangled” samples on each one of the aforesaid supports according to a defined order.

13) Device of implementation of the method according to claim 5 for the manufacture of the complex product according to claim 12 characterized in that it includes at least an apparatus of excitation proceeding to the aforementioned irradiation irradiating at a time at least one set of aforementioned samples together, the set of samples to be entangled, containing nuclei of at least one isomer nuclide having at least one metastable state, by means of gamma rays at least partly entangled, for example generated, either by a source of gamma rays emitted in a cascade, or by a generator of gamma rays coming from the Bremsstrahlung of accelerated particles, with a sufficient energy to excite the aforementioned nuclei of the isomer nuclide in at least one metastable state, at least two of the aforementioned “entangled” samples, of at least one set of “entangled” samples, being distributed on two or more supports, the “entangled” supports, according to the optimization of the apparatus of excitation.

14) Device of implementation of the method of use according to claim of use 7 applied to the complex product according to claim 12 characterized in that it includes at least one of the following apparatuses, insofar as it is intended to implement whole or part of the method of use, object of the aforesaid claim of use, located within the place covered by this patent, including aircrafts, marine vessels, submarines and spacecrafts, and the terrestrial, marine and space probes:
(a) one or several apparatuses for the aforementioned modulated stimulation, the “quantum transmitters”, applied to at least one of the aforementioned “entangled” samples, the “entangled” “master” sample, of at least one the aforementioned set of “entangled” samples pertaining to at least one of the aforementioned “entangled” supports, deexciting by X or gamma stimulation, one or several of the said “entangled” “masters” samples,
(b) one or several apparatuses of detection, the “quantum receivers”, for measuring simultaneously with the action of at least one of the aforesaid apparatuses for modulated stimulation, a gamma radiation coming from an additional modulated deexcitation on at least one characteristic line of at least one aforementioned isomer nuclide contained in at least one of the other aforementioned “entangled” samples, the “entangled” “slave” sample, of at least one the aforementioned set of “entangled” samples pertaining to at least one of the other aforementioned “entangled” supports, and in that this additional measured modulated deexcitation, is used to determine the reception of at least one information or to activate at least a command upon the remote control coming from the apparatus of stimulation.

15) Device of implementation according to claim 13 characterized in that the aforementioned “entangled” samples of one or more aforementioned sets of “entangled” samples are laid out on at least two aforementioned supports in the aforementioned apparatus of excitation, at least two of these said supports, the “entangled” supports, being thereafter separated for the utilization.

16) Device of implementation according to claim 13 characterized in that one uses only one aforementioned support for the aforementioned sets of samples to be entangled together, before their divisions, in the aforementioned apparatus of excitation, the said samples of each set, once “entangled”, being the subject of a division on at least two supports, the aforementioned “entangled” supports.

17) Device of implementation according to claim 14 characterized in that at least two of the aforementioned “entangled” supports are positioned in relation to each other, for example in synchronous relation, in the aforementioned apparatus or apparatuses of modulated stimulation, and in the aforementioned apparatus or apparatuses of detection, in such way that on at least one aforesaid “entangled” support, at least one aforementioned “entangled” slave sample is measured by at least one said apparatus of detection, when at least one aforementioned “entangled” “master” sample of the same aforementioned set of “entangled” samples located on one of the other aforementioned “entangled” supports is stimulated in at least one said apparatus of modulated stimulation.

18) Device of implementation according to claim 14 characterized in that aforementioned sets of “entangled” samples are arranged according to a defined order allowing the transmission and the reception of complex messages.

19) Utilization according to claim 7 to remotely transmit information, in particular emergency signals, remote controls, data acquisition, in the mines, sea-beds in particular by means of robots and submarines, in drillings, in the space field in particular at very long distances.

20) Product according to claim 1 for medical use in order to irradiate an organ in which at least an aforementioned “entangled” sample is laid out near or in the aforesaid organ, by causing a remote stimulation by means of at least one other aforementioned “entangled” sample.

21) Device of implementation of the method of use according to claim 7 for usage as a commercial kit of demonstration of whole or part of the method of use covered by the aforesaid claim.
